(19) United States
(12) Patent Application Publication
(10) Pub. No.: US 2006/0038988 A1
(43) Pub. Date: Feb. 23, 2006

(54) Borescope assembly for detecting a condition of a rotating part

(75) Inventor: Anthony Constantine Thermos, Greer, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 10/921,882

(22) Filed: Aug. 20, 2004

(51) Int. Cl. G01N 21/88

(52) U.S. Cl. 356/241.1

(57) ABSTRACT

A borescope assembly is suitable for detecting a condition of a rotating part. The assembly includes a borescope disposed in a borescope housing and including structure that relays an image to an image viewer. A plurality of fiber optic lines are disposed in the borescope housing, and a strobe light source is coupled with the fiber optic lines. An image processor is coupled with the image viewer. With this structure, the condition of a rotating part can be detected without stopping the part.

### BACKGROUND OF THE INVENTION

The present invention relates to a device for detecting a condition of a rotating part and, more particularly, to a borescope assembly incorporating fiber optic lines coupled with a strobe light source for detecting the rotating part condition.

Borescopes are commonly used for inspection of gas turbine engines to determine if there are any cracks or defects in rotating components such as the turbine blades. Existing borescopes are used to investigate internal parts of the units for cracks or overall integrity of the parts without the need of opening up the unit cover when the unit is cooled and not operating. Typically, the turbine engine includes strategically placed apertures into which a narrow borescope can be inserted. The borescope acts as a camera and delivers an image signal to a display. From the images, a condition of the rotating component, e.g., the existence of cracks, defects, oxidation, can be determined. Existing borescopes, however, are designed for static applications and are unable to view actively rotating components (e.g., turbine blades rotate 3000 RPMs or more during operation); as a consequence, the unit has to be stopped for inspection. The increased down time for inspection translates to increased operating costs. It would thus be desirable to provide a borescope assembly that is capable of inspecting rotating parts during operation.

### BRIEF DESCRIPTION OF THE INVENTION

In an exemplary embodiment of the invention, there is provided a borescope assembly for detecting a condition of a rotating part. The assembly includes a borescope disposed in a borescope housing. The borescope has structure that relays an image to an image viewer. A plurality of fiber optic lines are disposed in the borescope housing, and a strobe light source is coupled with the fiber optic lines. An image processor is coupled with the image viewer.

In another exemplary embodiment of the invention, the borescope assembly includes a borescope disposed in a borescope housing, the borescope including structure that relays an image to an image viewer. A plurality of fiber optic lines are disposed affixed to the borescope in the borescope housing, and a strobe light source is disposed in the borescope housing and coupled with the fiber optic lines. An image processor is coupled with the image viewer. The image processor receives the image from the image viewer and displays the image on a display.

### BRIEF DESCRIPTION OF THE DRAWINGS

FIG. 1 illustrates the borescope assembly of the present invention; and

FIGS. 2-4 illustrate alternative methods of securing the fiber optic lines to the borescope in the assembly.

### DETAILED DESCRIPTION OF THE INVENTION

Borescopes are known for inspection of gas turbine engines. See, for example, U.S. Pat. No. 6,333,812. As described therein, a borescope may include a tube having a distal end and a proximal end received within a housing or chassis. A side viewing in port is provided at the distal end of the tube, and a prismatic reflector is located adjacent the viewing port so as to reflect light from a laterally located object in the general direction of a longitudinal axis defined by the tube. The tube contains axially spaced relay lenses, which together comprise an optical relay operable to relay an image of an object being viewed through the tube to an image viewer within the housing. The image viewer may include an ocular lens mounted in a cylindrical ocular mount along with an eyepiece assembly. A dove prism may be mounted within the tube in order to correct image inversion resulting from reflection by the reflector. As noted, the structure and operation of a borescope are known, and further details thereof will not be described.

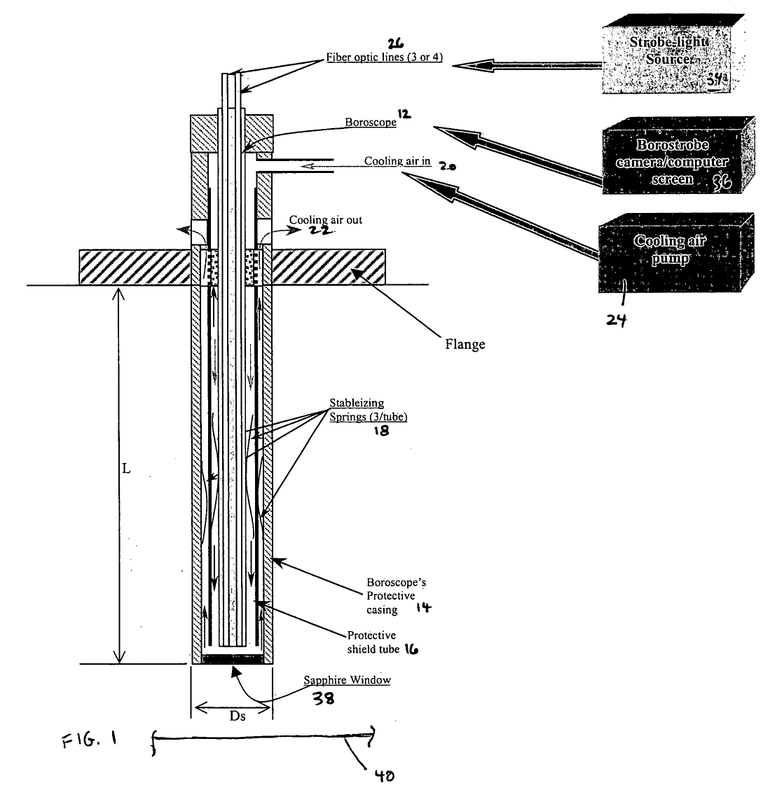

With reference to FIG. 1, the borescope assembly, so-called “Borostrobe”™, includes a borescope 12 disposed in a borescope housing 14. A protective shield tube 16 is disposed in the housing 14 surrounding the borescope 12, with a plurality of stabilizing springs (e.g., without limiting the invention, three springs per tube) 18 interposed between the protective shield tube 16 and the borescope 12 as well as between the protective shield tube 16 and the borescope housing 14.

The protective shield tube 16 serves to define a cooling path between a cooling air inlet 20 and a cooling air outlet 22. A cooling air pump 24 is disposed adjacent the cooling air inlet 20 for supplying cooling air to the cooling path. Other known gaseous coolants such as nitrogen may also be used. In some applications, e.g., in cooler parts of the engine such as inlets, borescope cooling may not be necessary, and such an apparatus could be constructed without a cooling path according to the intended use of the system. In this context, the cooling air pump 24 may simply be turned off or the protective shield tube 16 may be eliminated. Additionally, cooling air flow rates may vary per application by adjusting a flow rate of the cooling air pump 24 depending on the amount of cooling necessary (e.g., additional cooling for higher temperature locations, and less cooling for lower temperature locations). Still further, the assembly may be adapted via suitable piping and the like to utilize other cooling mediums, such as water or other liquid coolant.

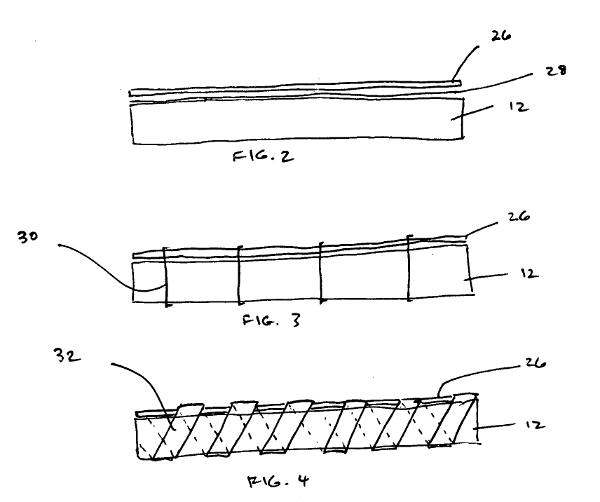

With continued reference to FIG. 1, a plurality of fiber optic lines (e.g., without limiting the invention, three or four lines) 26 are affixed to the borescope 12 within the borescope housing 14. As shown in FIGS. 2-4, the fiber optic lines 26 may be affixed to the borescope in any suitable manner. Exemplary methods for securing the fiber optic lines 26 to the borescope 12 include an adhesive 28 (FIG. 2), flexible clips 30 (FIG. 3), or a securing wrap 32 (FIG. 4).

A strobe light source 34 is coupled with the fiber optic lines 26. A frequency of a strobe light generated by the strobe light source 34 is adjusted by a triggering mechanism or the like to match the rotating speed of the rotor or other rotating part, thus matching the frequency of the rotating part passing in front of the borescope 12. By matching the strobe light frequency with the frequency of the rotating part, the part can be inspected without terminating operation of the unit. Moreover, by slightly modifying the strobe light frequency and then re-matching the strobe light frequency with the frequency of the rotating part in order to illuminate a different part, all of the rotating parts (e.g., blades) can be inspected in a very short time while the unit is still in operation.

An image processor 36, such as a borescope camera or computer screen, is coupled with the image viewer of the borescope 12 and receives and displays images from the borescope 12. A tip end of the borescope 12 is disposed adjacent a window 38 attached to the borescope housing 14. The window 38 allows the borescope 12 to focus at the target. Typically, the window 38 is formed from a high temperature resistant glass, such as sapphire glass, that is brazed hermetically to the borescope housing 14. The borescope housing 14 is preferably made of stainless steel to avoid rusting and oxidation.

The dimensions of the borescope assembly of the invention can be customized according to an intended use location. That is, the borescope assembly is typically inserted into an opening in a flange of the device containing the rotating part 40 (FIG. 1) to be inspected. A width or diameter D of the borescope assembly is slightly smaller than a corresponding width or diameter of the flange opening. The borescope assembly is inserted through the flange by distance L, which distance similarly varies depending on application. For example, if the assembly is installed in a compressor and inlet area of a gas turbine to monitor the forward blades of the rotating compressor rotor, then the length L of the assembly and the overall diameter D of the housing will be short and small, respectively. For hot gas path (HGP) locations, the dimensions are made larger. Typically, cooling will be required in hot gas path locations.

The borescope assembly of the invention incorporates fiber optic lines 26 connected to a strobe light source 34 and enables the detection of an operating condition (i.e., the existence of cracks, oxidation or other defects) of rotating parts, such as rotating turbine parts (e.g., blades) without stopping the machine from operating. Since down time equates to increased costs, by enabling inspection without requiring machine shut down, the structure thus saves time and costs in machine maintenance.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A borescope assembly for detecting a condition of a rotating part, the borescope assembly comprising:
a borescope disposed in a borescope housing, the borescope including structure that relays an image to an image viewer;
a plurality of fiber optic lines disposed in the borescope housing; and
a strobe light source coupled with the fiber optic lines.

2. A borescope assembly according to claim 1, wherein the borescope housing comprises a cooling path defined between a cooling medium inlet and a cooling medium outlet.

3. A borescope assembly according to claim 2, the borescope assembly further comprising a cooling air pump disposed adjacent the cooling medium inlet.

4. A borescope assembly according to claim 1, wherein the fiber optic lines are affixed to the borescope.

5. A borescope assembly according to claim 4, wherein the fiber optic lines are affixed to the borescope via an adhesive.

6. A borescope assembly according to claim 4, wherein the fiber optic lines are affixed to the borescope via flexible clips.

7. A borescope assembly according to claim 4, wherein the fiber optic lines are affixed to the borescope via a securing wrap.

8. A borescope assembly according to claim 11, wherein the image processor comprises at least one of a camera screen and a computer screen.

9. A borescope assembly according to claim 1, wherein the strobe light source is disposed within the borescope housing.

10. A borescope assembly according to claim 1, wherein a frequency of the strobe light source is adjustable to match a rotating speed of the rotating part.

11. A borescope assembly according to claim 1, the borescope assembly further comprising an image processor coupled with the image viewer.

12. A borescope assembly for detecting a condition of a rotating turbine part, the borescope assembly comprising:
a borescope disposed in a borescope housing, the borescope including structure that relays an image to an image viewer;
a plurality of fiber optic lines disposed affixed to the borescope in the borescope housing;
a strobe light source disposed in the borescope housing and coupled with the fiber optic lines; and
an image processor coupled with the image viewer, the image processor receiving the image from the image viewer and displaying the image on a display.

13. A method of inspecting a rotating part using the borescope assembly of claim 1, the method comprising:
placing the borescope housing, borescope and fiber optic lines adjacent the rotating part;
setting a frequency of the strobe light source to match a frequency of the rotating part; and
generating an image signal for displaying a condition of the rotating part.
